(19) United States
(12) Patent Application Publication
(10) Pub. No.: US 2016/0092438 A1
(43) Pub. Date: Mar. 31, 2016

(54) MACHINE TRANSLATION APPARATUS, MACHINE TRANSLATION METHOD AND PROGRAM PRODUCT FOR MACHINE TRANSLATION

(71) Applicant: KABUSHIKI KAISHA TOSHIBA, Tokyo (JP)

(72) Inventor: Satoshi Sonoo, Yokohama (JP)

(21) Appl. No.: 14/853,039

(22) Filed: Sep. 14, 2015

(30) Foreign Application Priority Data
Sep. 30, 2014 (JP) 2014-202631

(51) Int. Cl. G06F 17/28; G06F 17/27; G10L 15/26

(52) U.S. Cl. CPC G06F 17/289; G10L 15/26; G06F 17/2755; G06F 17/2785

(57) ABSTRACT

According to one embodiment, a machine translation apparatus includes a speech recognition unit that receives a speech input of a source language, recognizes the speech input of the source language, and generates a text of the source language, the speech input of the source language being sequentially-input, the text of the source language being the results of a speech recognition and an analysis information; a dividing unit that that decides a dividing position of units to be processed and information of order to be translated, based on the analysis information, the units to be processed being semantic units, each of the semantic units representing a partial meaning of the text of the source language; a machine translation unit that sequentially translates the units to be processed into a target language; a translation control unit that arranges the translated units based on the information of order to be translated and generates a text of the target language; and an output unit that outputs the text of the target language.

### CROSS REFERENCE TO RELATED APPLICATION

This application is based upon and claims the benefit of priority from Japanese Patent Application No. 2014-202631, filed on Sep. 30, 2014; the entire contents of which are incorporated herein by reference.

### FIELD

Embodiments described herein relate generally to a machine translation apparatus and associated methods.

### BACKGROUND

In recent years, natural language processing for spoken language is being developed. For example, machine translation technology for translating travel conversation using a personal digital assistant is a growing field. Sentences in travel conversation and dialogues between users are usually short. When each of the sentences is fully input and machine translation process is performed, there is little difficulty in the accuracy of communication of the intention between the users.

On the other hand, there is another utterance of spoken language known as a monologue, such as lecture presentation or briefing session. In a monologue, one speaker utters at a minimum a paragraph which has several sentences dealing with a single subject. When the monologue is subject to a machine translation process, each sentence in the paragraph is needed to gradually subjected to the machine translation process before the speaker has fully spoken the paragraph. Gradually performing machine translation process realizes high accuracy of the speaker's intention to audiences. Such machine translation process is called “incremental translation” or “simultaneous translation”.

Simultaneous translation continuously inputs utterances as source language text, divides source language text into units to be properly processed, and translates the units into target language. However, spoken language is different from written language (for example, newspaper articles and user manuals edited by proofreaders) and spoken language does not have punctuation marks that indicate to divide sentences and clauses. It is therefore difficult to properly divide sentences and clauses in spoken language.

To resolve the above difficulty, JP Pub. No. 2007-18098 discloses that source language text is divided by a pause (a short time during which speaker stops speaking) and performed morphological analysis, and the divided positions are corrected by a predetermined pattern to divide a monologue into units to be processed.

However, only incremental translation the units does not transform sentence structures and therefore generates results of machine translation that realizes low accuracy of the speaker's intention to audiences.

For example, it is considered a case that an utterance is processed speech recognition and source language text (Japanese text) “ [symbol] [symbol] [symbol] ” is input. This Japanese text is analyzed to divide three units to be processed (three clauses) “ [symbol] [symbol] / / [symbol] / / [symbol] .” “/ /” herein means a divided position of units to be processed. Incrementally translating the units can get the result of machine translation in English “an update of application // because a bug fixing is late // it will be next week.” However, the result is vague in point whether the word “it” means “an update of application ( [symbol] [symbol] ” or “a bug fixing ( [symbol] )” and then the result has trouble with the communication of the intention.

This disclosure aims to provide the machine translation apparatus and method solving the above mentioned subject.

### BRIEF DESCRIPTION OF THE DRAWINGS

FIG. 1 shows the entire of a machine translation apparatus 100 of one embodiment.

FIG. 2 shows the entire of a dividing unit 102.

FIG. 3 shows an example of result analyzed by a analysis unit.

FIG. 4 shows an example of text corpus of training set.

FIG. 5 shows an example of decision rule in translation order decision unit 204.

FIG. 6 shows the entire of a translation control unit.

FIG. 7 illustrates a flow chart of the operation of simultaneous machine translation process of the embodiment.

FIG. 8 shows the first example of controlling translation order in the simultaneous machine translation process.

FIG. 9 shows the second example of controlling translation order in case when speech input has time delay.

FIG. 10 shows the third example of controlling translation order in case when a result of speech recognition has recognition error.

FIG. 11 is a block diagram of an example computing environment that can be implemented in conjunction with one or more aspects described herein.

### DETAILED DESCRIPTION

According to one embodiment, a machine translation apparatus includes a speech recognition unit that receives a speech input of a source language, recognizes the speech input of the source language and generates a text of the source language, the speech input of the source language being sequentially-input, the text of the source language being the results of a speech recognition and an analysis information; a dividing unit that that decides a divided position of units to be processed and information of order to be translated, based on the analysis information, the units to be processed being semantic units, each of the semantic units representing a partial meaning of the text of the source language; a machine translation unit that sequentially translates the units to be processed into a target language; a translation control unit that arranges the translated units based on the information of order to be translated and generates a text of the target language; and an output unit that outputs the text of the target language.

Various Embodiments of the machine translation system will be described hereinafter with reference to the accompanying drawings.

### Exemplary Embodiment

This embodiment explains that source language is Japanese and target language is English. But a language pair of machine translation is not limited to the above case. The translation between any two languages or dialects can be performed.

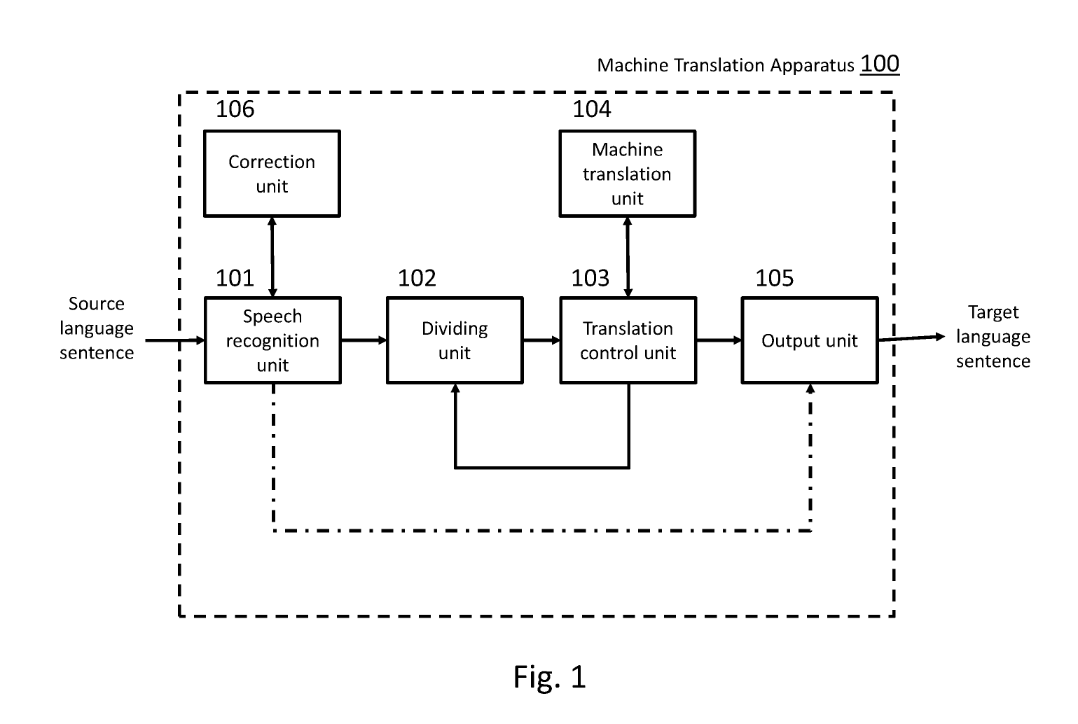

FIG. 1 shows the entire arrangement of a machine translation apparatus 100 of one embodiment. The apparatus 100 includes a speech recognition unit 101 receiving a speech input of the source language; a dividing unit 102; a translation control unit 103; a machine translation unit 104; an output unit 105 outputting text of the target language; and a correction unit 106.

The unit 101 receives a speech input of a source language as an input into the apparatus 100 and generates (a) a text of the source language as a result of a speech recognition and (b) a likelihood indicating degree of confidence in the result of the speech recognition. Processes of speech recognition are known as various conventional technologies such as Hidden Markov Model-based method. Since the technologies are known, a detailed explanation is omitted.

The dividing unit 102 receives (a) the text of the source language from the unit 101 and (b) time information of units being translated past from the unit 103, and generates units to be processed. The units to be processed include (a) parts of the text representing partial meanings of the text (for example, clauses, phrases, etc.) and (b) information of order to be translated representing whether the order to be translated can be changed or not.

The translation control unit 103 receives the units to be processed from the unit 102 and generates text of the target language being a result of machine translation translated by the unit 104.

The machine translation unit 104 receives text of the source language from the unit 103, generates text of the target language using machine translation, and sends the text of the target language to the unit 103. Processes of machine translation are known as various conventional technologies such as Rule Based Machine Translation, Example Based Machine Translation, or Statistical Machine Translation. Since the technologies are known, a detailed explanation is omitted.

The output unit 105 outputs the text of the target language generated by the unit 103. The unit 105 also can output the text of the source language recognized by the unit 101 and the likelihood. Therefore, if the likelihood is less than or equal to a predetermined threshold, a part of the text of the source language corresponding to the likelihood can be annotated and be output to urge the user to correct the result of the speech recognition. The text to output can be output from any output device such as a display device (not shown), a printer device (not shown), or a speech synthesis device (not shown). The output devices can be changed over or concurrently used.

The correction unit 106 responds to a user's operation and corrects the results of the speech recognition if necessary. Ways to correct can be input devices such as a keyboard device (not shown), a mouse device, or operation of restating using a speech input device. Furthermore, candidates of correction are received from the unit 101 and user is urged to select one of the candidates to execute correction.

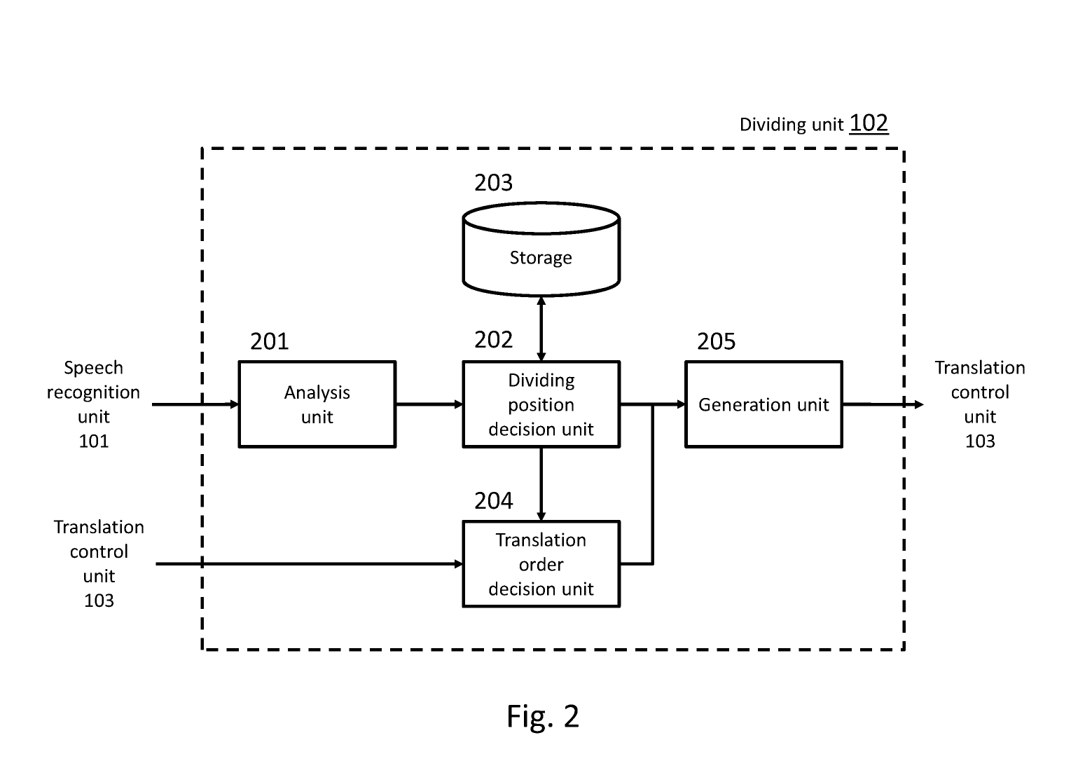

FIG. 2 shows the entire arrangement of the dividing unit 102. The unit 102 includes an analysis unit 201 receiving the text of the source language from the unit 101; a dividing position decision unit 202; a storage 203; a translation order decision unit 204; and a generation unit 205.

The analysis unit 201 performs morphological analysis of the text of the source language to divide units of morpheme and acquire parts-of-speeches of the units, performs syntax analysis of the text of the source language to acquire grammatical relationships between and/or among clauses and/or phrases of the text of the source language, and then acquires analysis information.

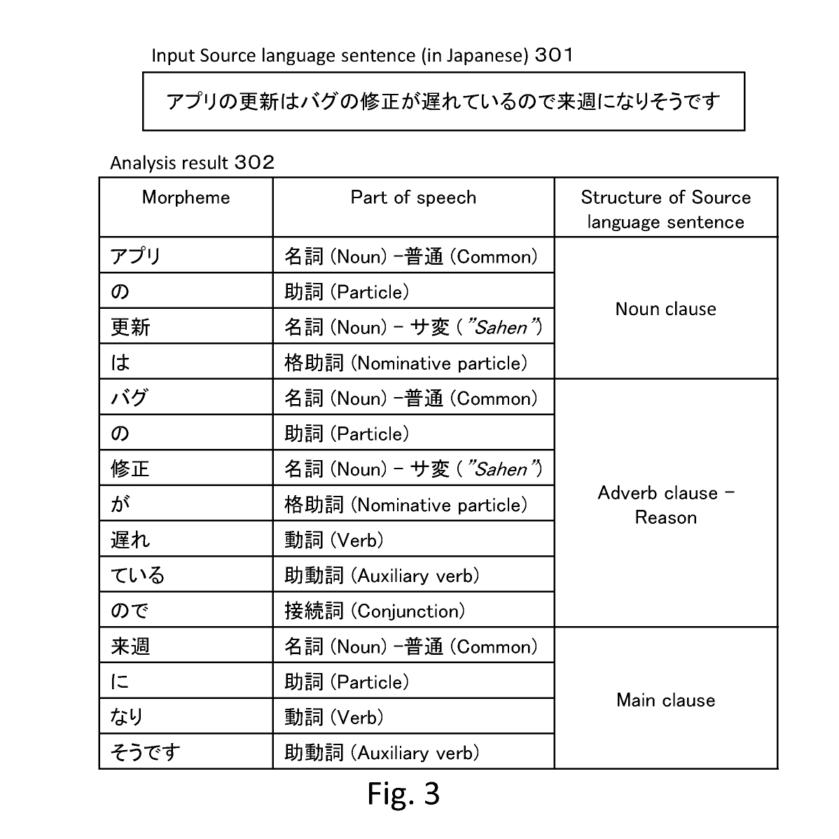

FIG. 3 shows an example of a result analyzed by the unit 201. The analysis unit 201 inputs Source language sentence 301 “ [symbol] [symbol] [symbol] ”, analyzes the sentence 301 and then outputs Analysis result 302. The analysis result 302 represents that the part-of-speech of the morpheme “ [symbol] ” is a conjunction, a phrase “ [symbol] [symbol] ” is a partial meaning of the sentence 301 (that is, clause) and “Adverb clause—Reason” as syntax information.

The dividing position decision unit 202 receives the analysis result 302, and checks the result 302 with the storage 203, and then decides a dividing position of the sentence 301.

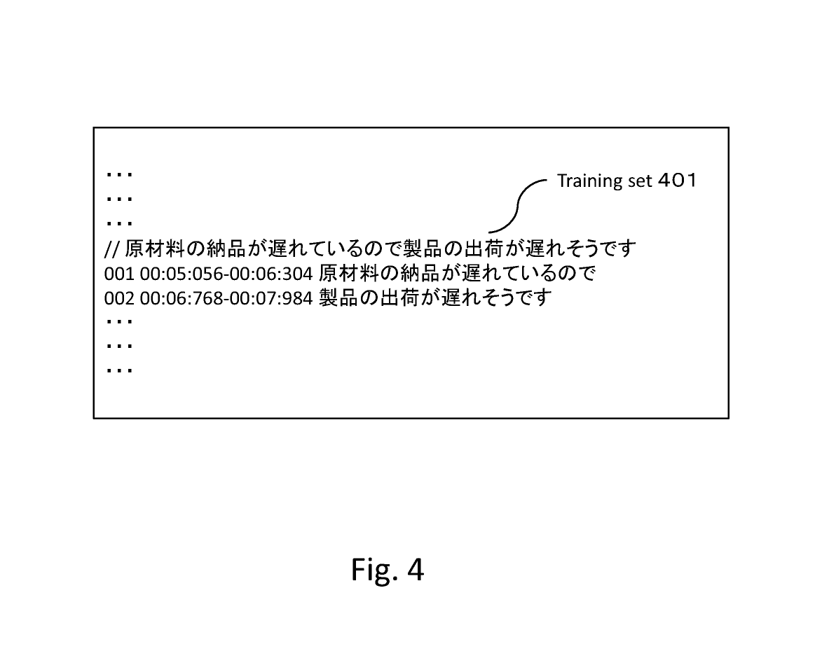

The storage 203 stores a decision model constructed by text corpus of training set. FIG. 4 shows an example of text corpus of training set. The text corpus of training set includes sets of training set 401 being some text with a predetermined dividing position and time information of utterance. The training set 401 divides training sentence “ [symbol] , [symbol] [symbol] ” into the first clause “ [symbol] [symbol] ” and the second clause “ [symbol] ”, and stores time information of the uttered clauses. The decision model can be constructed by machine learning techniques such as Conditional Random Field or rules made by human beings. For example, the rules made by human beings include a rule of dividing before and after “ [symbol] ” as the decision standard corresponding to the training set 401.

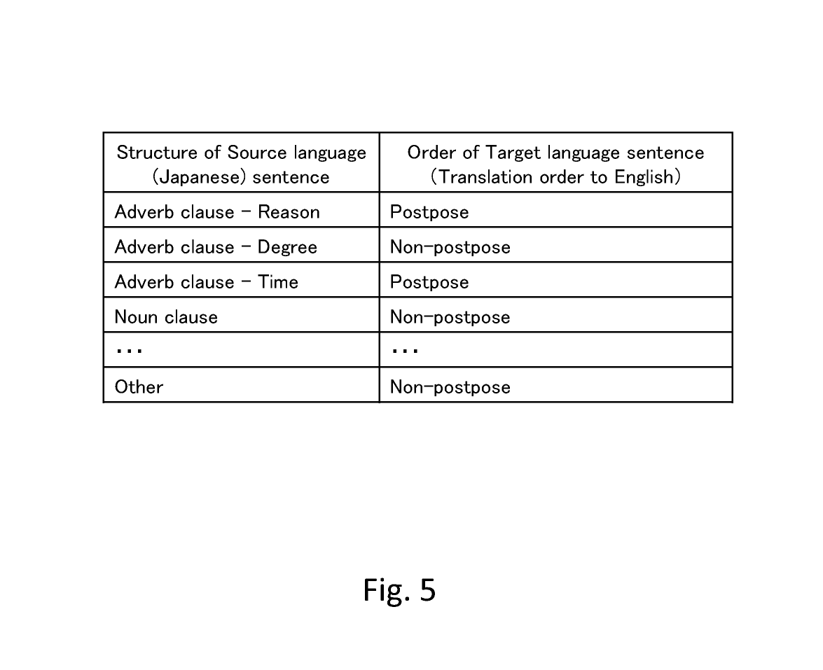

The translation order decision unit 204 decides the information of order to be translated representing whether the order to be translated, for the units to be processed being divided by the unit 202, can be changed or not. FIG. 5 shows an example of decision rule in the translation order decision unit 204. The decision rule represents structures of source language (Japanese, for example) sentence and order information of target language sentence (that is, in order to be translated into English, for example).

When the first clause “ [symbol] [symbol] ” is a unit to be processed and the syntax information “Adverb clause—Reason”, the unit 204 decides that the information of order to be translated into target language is “Postpose”. The unit 202 also has a function of correcting the information of order to be translated by comparing a current time information (that is, a time when the unit 101 receives speech input of source language) and another time information regarding to the translated past unit to be processed in past times being received from the unit 103.

The unit 205 receives both decision results from the unit 202 and the unit 204 and generates units to be processed including (a) a part of text of source language and (b) the information of order to be translated representing whether the order of the part of text can be changed or not.

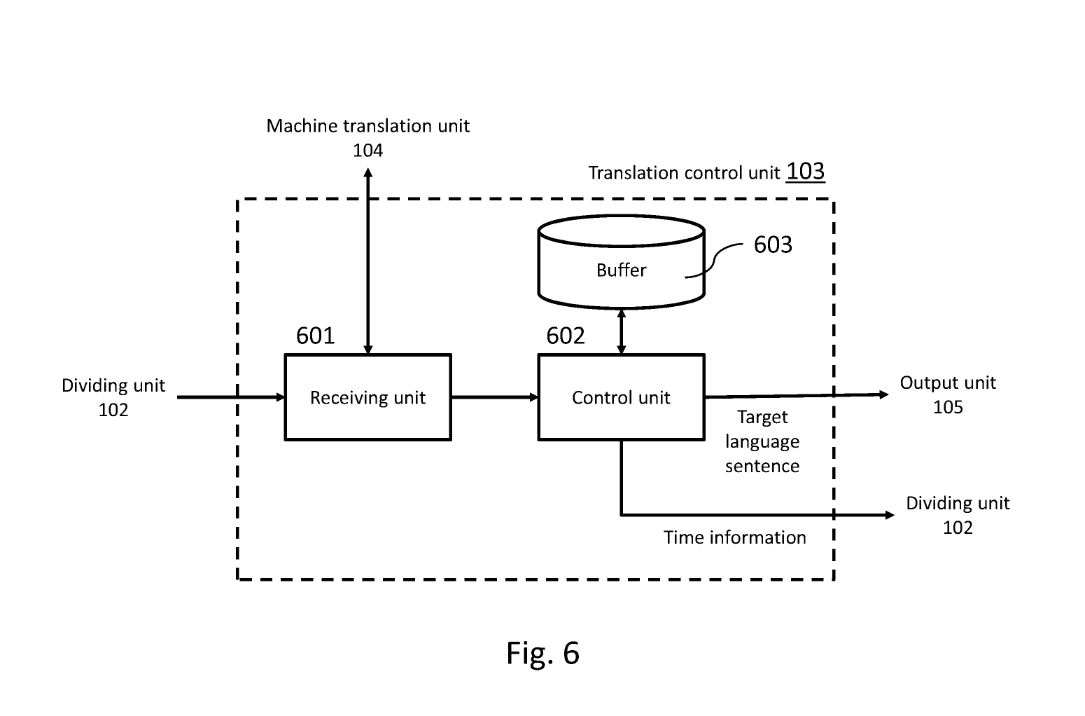

FIG. 6 shows the entire arrangement of the translation control unit 103. The unit 103 includes a receiving unit 601, a control unit 602, and a buffer 603.

The receiving unit 601 receives units to be processed of source language text from the unit 102, input the units of source language into the unit 104, and acquires the translation result of target language from the unit 104.

The dividing unit 102 controls order of machine translation based on the information of order to be translated of units to be processed. For example, when the information of order to be translated is “Postpose”, the unit 602 stores the current translation result in the buffer 603. When the information of order to be translated is “Non-postpose”, the unit 602 adds the current translation result to the past translation result stored in the buffer 603 and generates text of the target language. The unit 602 outputs the text of target language to the unit 105 and information of the output time to the unit 102.

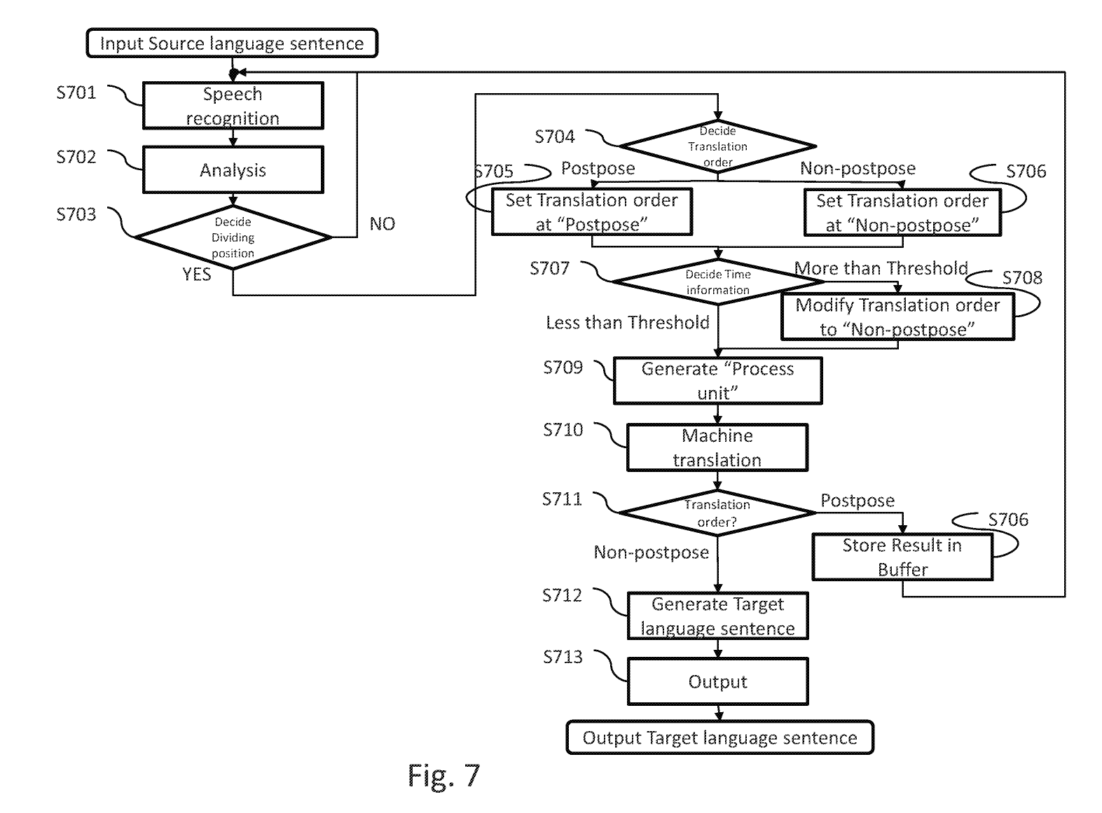

FIG. 7 illustrates a flow chart of the operation of simultaneous machine translation process of the apparatus 100.

The speech recognition unit 101 receives input of source language and performs speech recognition (S701).

The analysis unit 201 analyzes text of source language (S702) and generates a result.

The dividing position decision unit 202 receives the analysis result from the unit 201 and decides units of text of source language to be processed (S703). If the end position of current text of source language is NOT decided a dividing position (No in S703), the process returns the speech recognition process (S701).

When the end position of current text of source language is decided a dividing position (Yes in S703), the unit 204 performs the translation order decision of units to be processed (S704). If the unit to be processed is decided “Postpose” (Postpose in S704), the unit 204 sets the information of translation order to “Postpose”. If the unit to be processed is decided “Non-postpose” (Non-postpose in S704), the unit 204 sets the information of translation order to “Non-postpose” (S706).

The translation order decision unit 204 calculates a translation interval (that is, time difference information) from current time information and the past output time information and compares the translation interval with the predetermined threshold (S707). If the translation interval is greater than the threshold (More than threshold in S707), the unit 204 corrects the translation order information to “Non-postpose” (S708).

The generation unit 205 receives the dividing position information and the translation order information and generates units to be processed (S709).

The receiving unit 601 receives the units to be processed. The unit 104 translates the input source language text into target language and generates the result of machine translation.

If the translation order information is “Postpose” (Postpose in S711), the unit 602 stores the translation result in the buffer 603 and the process returns to the speech recognition process (S701). If the translation order information is “Not-postpose” (Postpose is S711), the unit 602 adds the translation result to the other translation result stored in the buffer 603 and generates target source language text (S712).

Finally, the output unit 105 receives the target source language text and performs output in target language (S713). The whole process then ends.

In an optional aspect of the embodiment, if the unit 106 corrects the result of the speech recognition, the whole processes is similar to the above explanation.

According to the above embodiment, the machine translation apparatus detects units to be processed for continuously input source language text and controls sequence order of translation result per the units to be processed, based on the order information of the units to be processed. Therefore the machine translation process can keep operating as simultaneous as possible with spoken language, can acquire clear translation results and can realize high accuracy of the speaker's intention and communication to audiences.

Three examples of the simultaneous machine translation process of the embodiment are described hereinafter.

### First Example

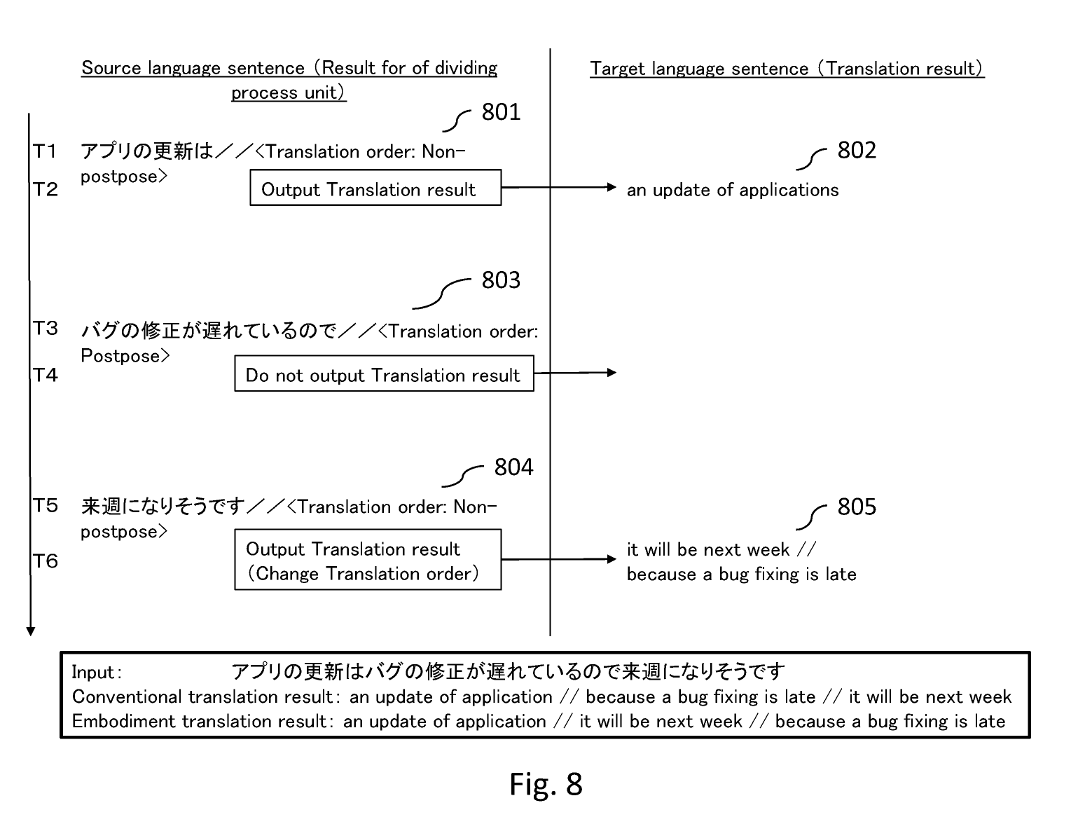

FIG. 8 shows a first example of controlling translation order in the simultaneous machine translation process. This example explains processes in chronological order that a speech corresponding to a source language text “ [symbol] [symbol] [symbol] ” is serially input and the unit 101 correctly acquires the source language text.

In time T1, the dividing unit 102 acquires a unit to be processed 801 “ [symbol] [symbol] //<Translation order information: Non-postpose>”. In the translation order information “Non-postpose”, the unit 103 decides that output order of a translation result 802 “an update of applications” translated by the unit 104 is “Non-delay” and outputs the translation result 802 to the unit 105 (Time T2).

In time T3, the unit 102 acquires a unit to be processed 803 “ [symbol] [symbol] //<Translation order information: Postpose>”. In the translation order information “Postpose”, the unit 103 controls that the output of the translation result is delayed (Time T4).

In time T5, the unit 102 acquires a unit to be processed 804 “ [symbol] [symbol] //<Translation order information: Non-postpose>”. IN the translation order information “Non-postpose”, the unit 103 adds the translation result of the unit to be processed 804 to the other translation result stored by the buffer 603 and outputs a translation result 805 “it will be next week // because a bug fixing is late” (Time T6). The final translation result is “an update of application // it will be next week // because a bug fixing is late”. “Bug fixing” is also called “bug fix” or “bug-fix”.

The first example is that the result phrase is translated more former than the main clause, the adverb clause representing the reason modifies the whole sentence, and can acquire the translation result being low ambiguous and high accuracy of the speaker's intention to audiences.

### Second Example

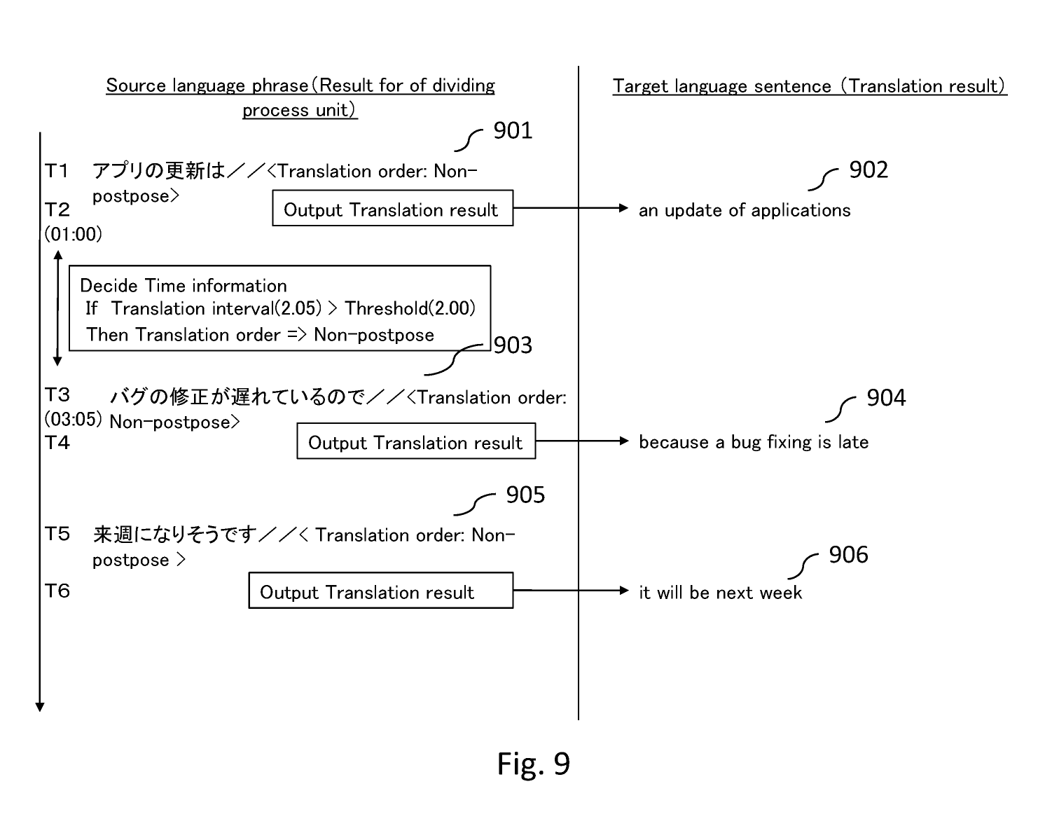

FIG. 9 shows a second example of controlling translation order in case when speech input has a time delay. This example explains a simultaneous translation process in case when speech input has time delay factor such as “Pause”, “Filler” or “Falter”. The following explanation is set in a case when a threshold of time information in S707 is 2.00 seconds (although any time threshold can be selected).

In time T1, the dividing unit 102 acquires a unit to be processed 901 “ [symbol] [symbol] //<Translation order information: Non-postpose>”. In the translation order information “Non-postpose”, the unit 103 outputs a translation result 902 “an update of applications” translated by the unit 104. The time T2 is 01:00.

It is assume that the time delay factor occurs time delay during outputting the translation result 902 through acquiring the next source language text and the dividing process performs at time T3 (03:05). In this case, if the following processes continue based on the original translation order information “Postpose”, time delay of translation results is increasing more and simultaneity is damaged.

In order to solve the above problem, the second example calculates a translation interval based on output time information of the last translation result and current time information, and compares the translation interval with the threshold, and modifies the translation order information. Therefore, the second example acquires a unit to be processed 903 “ [symbol] //<Translation order information: Postpose>” and outputs a translation result 904 “because a bug fixing is late”.

The second example, similar to the first example, outputs a translation result 906 “it will be next week” corresponding to a unit to be processed 905 “ [symbol] [symbol] //<Translation order information: Non-postpose>” and acquires final translation results “an update of application // because a bug fixing is late // it will be next week”. The second example can ensure simultaneously in case of occurring time delay of speech input.

### Third Example

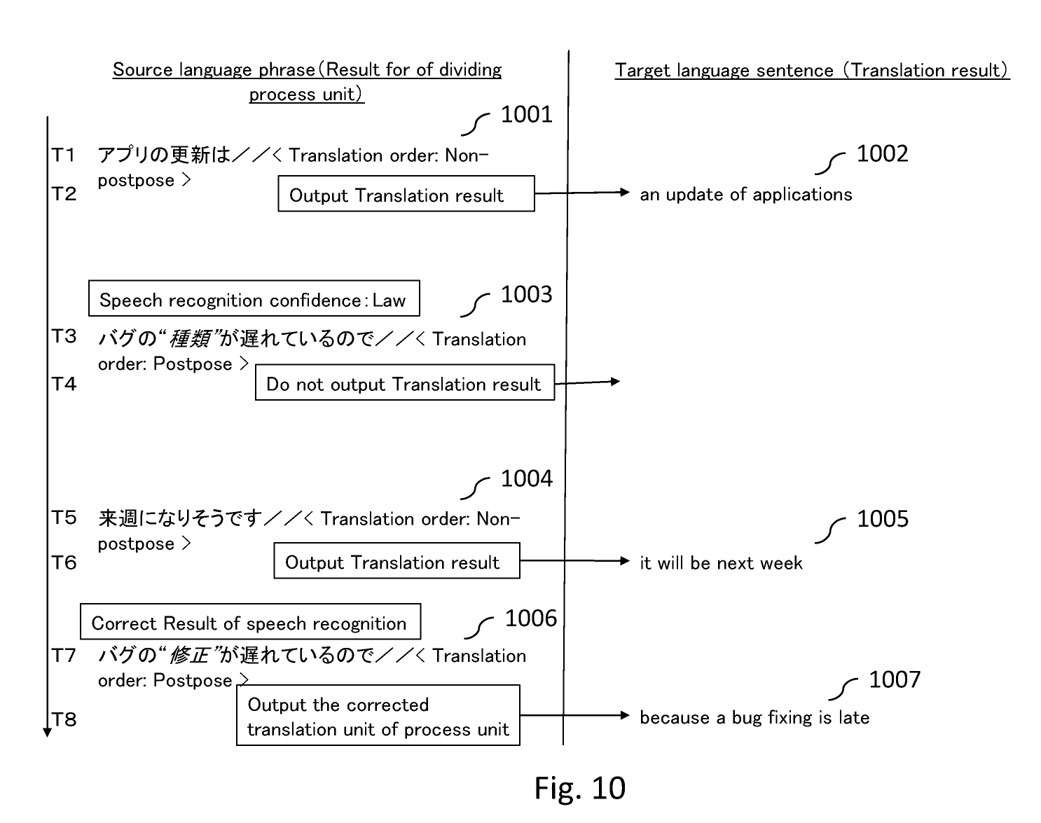

FIG. 10 shows a third example of controlling translation order in case when a result of speech recognition has a recognition error. If source language text are speech recognition results of speech inputs, the speech recognition results are likely to include errors and need to be corrected during processing of simultaneous translation. The situation has a problem that simultaneity is damaged, because correcting of the speech recognition result of a unit to be processed including the error has completed and then outputting the translation result of the following unit to be processed.

This example explains correcting the speech recognition results in case when the results are displayed on a display (not shown) and the user (speaker in source language) decides that the results have an error. The likelihood of the results is also displayed on the display.

The following explanation is set in case when “ [symbol] ” is wrongly recognized in Time T3 and the error is corrected to “ [symbol] ” by a keyboard device (not shown). But methods of inputting correct are not limited to the keyboard device.

In time T1, the unit 102 acquires a unit to be processed 1001 “ [symbol] [symbol] //<Translation order information: Non-postpose>”. In the translation order information “Non-postpose”, the unit 103 outputs the translation results 1002 “an update of applications” translated by the unit 104.

In time T3, the unit 102 acquires a unit to be processed 1003 “ [symbol] [symbol] //<Translation order information: Postpose>”. In the translation order information “Postpose”, the unit 103 controls that the output of the translation result is delayed (Time T4).

When the likelihood of the unit to be processed 1003 is low, the user knows that the unit to be processed 1003 has an error of the speech recognition results and can correct the results by the unit 106. The correction of the unit 106 clears the translation results stored by the buffer 603.

The conventional method has a problem that simultaneity is damaged, because correcting of the speech recognition result of a unit to be processed including the error has completed and then outputting the translation result of the following unit to be processed.

However, this example asynchronously controls outputs of units to be processed and then can in parallel execute correction of speech recognition results and input of the following unit to be processed. The delay of outputting the translation results including the error of speech recognition can avoid misunderstanding from, and also has the effect of realizing high accuracy of the source language speaker's intention to audiences.

In time 15, the unit 102 acquires the unit to be processed 1004 “ [symbol] [symbol] //<Translation order information: Non-postpose>”. In the translation order information “Non-postpose”, the unit 103 outputs the translation results 1005 “it will be next week” (Time T6).

In time T7, correction of the speech recognition result has completed, the unit to be processed 1006 “ [symbol] //<Translation order information: Postpose>” is acquired, the corrected translation result 1007 “because a bug fixing is late” is output (Time T8). Even in case when the result of speech recognition has the error of the speech recognition, the example can ensure simultaneity and realize high accuracy of the simultaneous machine translation of the speaker's intention to audiences.

According to machine translation apparatus of at least one embodiment described above, in simultaneous translation such as monologue, can perform dividing process and machine translation of source language text so that high communication of the monologue speaker's intention to audiences can be realized.

The flow charts of the embodiments illustrate methods and systems according to the embodiments. It will be understood that each block of the flowchart illustrations, and combinations of blocks in the flowchart illustrations, can be implemented by computer program instructions. These computer program instructions can be loaded onto a computer or other programmable apparatus to produce a machine, such that the instructions which execute on the computer or other programmable apparatus create means for implementing the functions specified in the flowchart block or blocks. These computer program instructions can also be stored in a non-transitory computer-readable memory that can direct a computer or other programmable apparatus to function in a particular manner, such that the instruction stored in the non-transitory computer-readable memory produce an article of manufacture including instruction means which implement the function specified in the flowchart block or blocks. The computer program instructions can also be loaded onto a computer or other programmable apparatus/device to cause a series of operational steps/acts to be performed on the computer or other programmable apparatus to produce a computer programmable apparatus/device which provides steps/acts for implementing the functions specified in the flowchart block or blocks.

Example Computing Environment

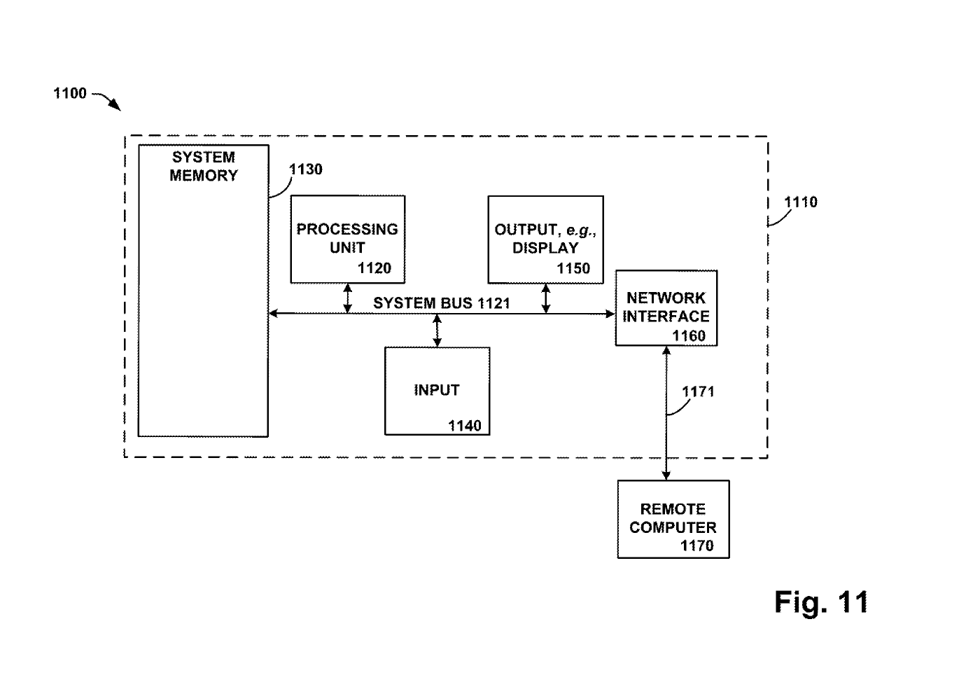

As mentioned, advantageously, the techniques described herein can be applied to language translation and associated methods. It is to be understood, therefore, that handheld, portable and other computing devices and computing objects of all kinds are contemplated for use in connection with the various non-limiting embodiments. Accordingly, the below general purpose remote computer described below in FIG. 11 is but one example, and the disclosed subject matter can be implemented with any client having network/bus interoperability and interaction. Thus, the disclosed subject matter can be implemented in an environment of networked hosted services in which very little or minimal client resources are implicated, e.g., a networked environment in which the client device serves merely as an interface to the network/bus, such as an object placed in an appliance.

Although not required, some aspects of the disclosed subject matter can partly be implemented via an operating system, for use by a developer of services for a device or object, and/or included within application software that operates in connection with the component(s) of the disclosed subject matter. Software may be described in the general context of computer executable instructions, such as program modules or components, being executed by one or more computer(s), such as projection display devices, viewing devices, or other devices. Those skilled in the art will appreciate that the disclosed subject matter may be practiced with other computer system configurations and protocols.

FIG. 11 thus illustrates an example of a suitable computing system environment 1100 in which some aspects of the disclosed subject matter can be implemented, although as made clear above, the computing system environment 1100 is only one example of a suitable computing environment for a device and is not intended to suggest any limitation as to the scope of use or functionality of the disclosed subject matter. Neither should the computing system environment 1100 be interpreted as having any dependency or requirement relating to any one or combination of components illustrated in the exemplary computing system environment 1100.

With reference to FIG. 11, an exemplary device for implementing the disclosed subject matter includes a general-purpose computing device in the form of a computer 1110. Components of computer 1110 may include, but are not limited to, a processing unit 1120, a system memory 1130, and a system bus 1121 that couples various system components including the system memory to the processing unit 1120. The system bus 1121 may be any of several types of bus structures including a memory bus or memory controller, a peripheral bus, and a local bus using any of a variety of bus architectures.

Computer 1110 typically includes a variety of computer readable media. Computer readable media can be any available media that can be accessed by computer 1110. By way of example, and not limitation, computer readable media can comprise computer storage media, non-transitory media, and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1110. Communication media typically embodies computer readable instructions, data structures, program modules, or other data in a modulated data signal such as a carrier wave or other transport mechanism and includes any information delivery media.

The system memory 1130 may include computer storage media in the form of volatile and/or nonvolatile memory such as read only memory (ROM) and/or random access memory (RAM). A basic input/output system (BIOS), containing the basic routines that help to transfer information between elements within computer 1110, such as during start-up, may be stored in memory 1130. Memory 1130 typically also contains data and/or program modules that are immediately accessible to and/or presently being operated on by processing unit 1120. By way of example, and not limitation, memory 1130 may also include an operating system, application programs, other program modules, and program data.

The computer 1110 may also include other removable/non-removable, volatile/nonvolatile computer storage media. For example, computer 1110 could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. A hard disk drive is typically connected to the system bus 1121 through a non-removable memory interface such as an interface, and a magnetic disk drive or optical disk drive is typically connected to the system bus 1121 by a removable memory interface, such as an interface.

A user can enter commands and information into the computer 1110 through input devices such as a keyboard and pointing device, commonly referred to as a mouse, trackball, or touch pad. Other input devices can include a microphone, joystick, game pad, satellite dish, scanner, wireless device keypad, voice commands, or the like. These and other input devices are often connected to the processing unit 1120 through user input 1140 and associated interface(s) that are coupled to the system bus 1121, but may be connected by other interface and bus structures, such as a parallel port, game port, or a universal serial bus (USB). A graphics subsystem can also be connected to the system bus 1121. A projection unit in a projection display device, or a HUD in a viewing device or other type of display device can also be connected to the system bus 1121 via an interface, such as output interface 1150, which may in turn communicate with video memory. In addition to a monitor, computers can also include other peripheral output devices such as speakers which can be connected through output interface 1150.

The computer 1110 can operate in a networked or distributed environment using logical connections to one or more other remote computer(s), such as remote computer 1170, which can in turn have media capabilities different from computer 1110. The remote computer 1170 can be a personal computer, a server, a router, a network PC, a peer device, personal digital assistant (PDA), cell phone, handheld computing device, a projection display device, a viewing device, or other common network node, or any other remote media consumption or transmission device, and may include any or all of the elements described above relative to the computer 1110. The logical connections depicted in FIG. 11 include a network 1171, such local area network (LAN) or a wide area network (WAN), but can also include other networks/buses, either wired or wireless. Such networking environments are commonplace in homes, offices, enterprise-wide computer networks, intranets and the Internet.

When used in a LAN networking environment, the computer 1110 can be connected to the LAN 1171 through a network interface or adapter. When used in a WAN networking environment, the computer 1110 can typically include a communications component, such as a modem, or other means for establishing communications over the WAN, such as the Internet. A communications component, such as wireless communications component, a modem and so on, which can be internal or external, can be connected to the system bus 1121 via the user input interface of input 1140, or other appropriate mechanism. In a networked environment, program modules depicted relative to the computer 1110, or portions thereof, can be stored in a remote memory storage device. It will be appreciated that the network connections shown and described are exemplary and other means of establishing a communications link between the computers can be used.

As utilized herein, terms “component,” “system,” “engine,” “architecture” and the like are intended to refer to a computer or electronic-related entity, either hardware, a combination of hardware and software, software (e.g., in execution), or firmware. For example, a component can be one or more transistors, a memory cell, an arrangement of transistors or memory cells, a gate array, a programmable gate array, an application specific integrated circuit, a controller, a processor, a process running on the processor, an object, executable, program or application accessing or interfacing with semiconductor memory, a computer, or the like, or a suitable combination thereof. The component can include erasable programming (e.g., process instructions at least in part stored in erasable memory) or hard programming (e.g., process instructions burned into non-erasable memory at manufacture).

By way of illustration, both a process executed from memory and the processor can be a component. As another example, an architecture can include an arrangement of electronic hardware (e.g., parallel or serial transistors), processing instructions and a processor, which implement the processing instructions in a manner suitable to the arrangement of electronic hardware. In addition, an architecture can include a single component (e.g., a transistor, a gate array, . . . ) or an arrangement of components (e.g., a series or parallel arrangement of transistors, a gate array connected with program circuitry, power leads, electrical ground, input signal lines and output signal lines, and so on). A system can include one or more components as well as one or more architectures. One example system can include a switching block architecture comprising crossed input/output lines and pass gate transistors, as well as power source(s), signal generator(s), communication bus(ses), controllers, I/O interface, address registers, and so on. It is to be appreciated that some overlap in definitions is anticipated, and an architecture or a system can be a stand-alone component, or a component of another architecture, system, etc.

In addition to the foregoing, the disclosed subject matter can be implemented as a method, apparatus, or article of manufacture using typical manufacturing, programming or engineering techniques to produce hardware, firmware, software, or any suitable combination thereof to control an electronic device to implement the disclosed subject matter. The terms “apparatus” and “article of manufacture” where used herein are intended to encompass an electronic device, a semiconductor device, a computer, or a computer program accessible from any computer-readable device, carrier, or media. Computer-readable media can include hardware media, or software media. In addition, the media can include non-transitory media, or transport media. In one example, non-transitory media can include computer readable hardware media. Specific examples of computer readable hardware media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Computer-readable transport media can include carrier waves, or the like. Of course, those skilled in the art will recognize many modifications can be made to this configuration without departing from the scope or spirit of the disclosed subject matter.

What has been described above includes examples of the subject innovation. It is, of course, not possible to describe every conceivable combination of components or methodologies for purposes of describing the subject innovation, but one of ordinary skill in the art can recognize that many further combinations and permutations of the subject innovation are possible. Accordingly, the disclosed subject matter is intended to embrace all such alterations, modifications and variations that fall within the spirit and scope of the disclosure. Furthermore, to the extent that a term “includes”, “including”, “has” or “having” and variants thereof is used in either the detailed description or the claims, such term is intended to be inclusive in a manner similar to the term “comprising” as “comprising” is interpreted when employed as a transitional word in a claim.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. Additionally, some portions of the detailed description have been presented in terms of algorithms or process operations on data bits within electronic memory. These process descriptions or representations are mechanisms employed by those cognizant in the art to effectively convey the substance of their work to others equally skilled. A process is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise or apparent from the foregoing discussion, it is appreciated that throughout the disclosed subject matter, discussions utilizing terms such as processing, computing, calculating, determining, or displaying, and the like, refer to the action and processes of processing systems, and/or similar consumer or industrial electronic devices or machines, that manipulate or transform data represented as physical (electrical and/or electronic) quantities within the registers or memories of the electronic device(s), into other data similarly represented as physical quantities within the machine and/or computer system memories or registers or other such information storage, transmission and/or display devices.

In regard to the various functions performed by the above described components, architectures, circuits, processes and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In addition, while a particular feature may have been disclosed with respect to only one of several implementations, such feature may be combined with one or more other features of the other implementations as may be desired and advantageous for any given or particular application. It will also be recognized that the embodiments include a system as well as a computer-readable medium having computer-executable instructions for performing the acts and/or events of the various processes.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A machine translation apparatus comprising:
a processor comprising:
a speech recognition unit that receives a speech input of a source language, recognizes the speech input of the source language and generates a text of the source language, the speech input of the source language being sequentially-input, the text of the source language being the results of a speech recognition and an analysis information;
a dividing unit that that decides a dividing position of units to be processed and information of order to be translated, based on the analysis information, the units to be processed being semantic units, each of the semantic units representing a partial meaning of the text of the source language;
a machine translation unit that sequentially translates the units to be processed into a target language;
a translation control unit that arranges the translated units based on the information of order to be translated and generates a text of the target language; and
an output unit that outputs the text of the target language.

2. The apparatus according to claim 1, wherein the units to be processed comprises clauses.

3. The apparatus according to claim 1, wherein the analysis information includes the results of a morphological analysis and a syntax analysis of the text of the source language;
the information of order to be translated represents whether an order to be output is able to be delayed, the order to be output representing the order to be output from a buffer, the buffer comprising a translation result of current units to be processed;
the dividing unit includes a dividing position decision unit that decides a dividing position of the units to be processed based on the results of the morphological analysis and a translation order decision unit that decides the information of the order to be translated based on the results of the syntax analysis;
the translation control unit, (a) if the information of the order to be translated is able to be delayed, delays outputting the translation result of the current units to be processed, (b) if the information of the order to be translated is not able to be delayed, adds the translation result of the current units to be processed to a non-output translation result of another unit to be processed to generate the text of the target language.

4. The apparatus according to claim 3, wherein the dividing unit corrects the information of the order to be translated based on a difference between a time information according to a previously translated process and another time information according to a currently translated process.

5. The apparatus according to claim 3, wherein the result of the syntax analysis represents whether the text of the source language divided by the divided position is a subordinate clause.

6. The apparatus according to claim 3 further comprising:
a correction unit that corrects a result of the speech recognition unit;
the translation control unit that adds, a translation result of the text of the source language corrected by the correction unit, to the current translation result, according to the information of order to be translated, to generate the text of the target language.

7. A machine translation method executed on a processor comprising:
receiving a speech input of a source language, recognizing the speech input of the source language, and generating a text of the source language, the speech input of the source language being sequentially-input, the text of the source language being the results of a speech recognition and an analysis information;
deciding a dividing position of units to be processed and information of order to be translated, based on the analysis information, the units to be processed being semantic units, each of the semantic units representing a partial meaning of the text of the source language;
sequentially translating the units to be processed into a target language;
arranging the translated units based on the information of order to be translated and generating a text of the target language; and
outputting the text of the target language.

8. The method according to claim 7, wherein the analysis information includes the results of a morphological analysis and a syntax analysis of the text of the source language;
the information of order to be translated represents whether an order to be output is able to be delayed, the order to be output representing the order to be output;
deciding a dividing position of the units to be processed based on the results of the morphological analysis and deciding the information of the order to be translated based on the results of the syntax analysis;
(a) if the information of the order to be translated is able to be delayed, delaying outputting the translation result of the current units to be processed, and
(b) if the information of the order to be translated is not able to be delayed, adding the translation result of the current units to be processed to a non-output translation result of another unit to be processed to generate the text of the target language.

9. The method according to claim 8, further comprising correcting the information of the order to be translated based on a difference between a time information according to a previously translated process and another time information according to a currently translated process.

10. The method according to claim 8, wherein the result of the syntax analysis represents whether the text of the source language divided by the divided position is a subordinate clause.

11. The method according to claim 8 further comprising:
correcting a result of the speech recognition unit; and
adding, a translation result of the text of the source language corrected, to the current translation result, according to the information of order to be translated, to generate the text of the target language.

12. A computer program product comprising a non-transitory computer readable medium comprising programmed instructions stored in a memory for performing a machine translation processing, comprising:
a speech recognition unit that receives a speech input of a source language, recognizes the speech input of the source language, and generates a text of the source language, the speech input of the source language being sequentially-input, the text of the source language being the results of a speech recognition and an analysis information;
a dividing unit that that decides a dividing position of units to be processed and information of order to be translated, based on the analysis information, the units to be processed being semantic units, each of the semantic units representing a partial meaning of the text of the source language;
a machine translation unit that sequentially translates the units to be processed into a target language;
a translation control unit that arranges the translated units based on the information of order to be translated and generates a text of the target language; and
an output unit that outputs the text of the target language.

13. The product according to claim 12, wherein the units to be processed comprise clauses.

14. The product according to claim 12, wherein the analysis information includes the results of a morphological analysis and a syntax analysis of the text of the source language;
the information of order to be translated represents whether an order to be output is able to be delayed, the order to be output representing the order to be output from a buffer, the buffer comprising a translation result of current units to be processed;
the dividing unit includes a dividing position decision unit that decides a dividing position of the units to be processed based on the results of the morphological analysis and a translation order decision unit that decides the information of the order to be translated based on the results of the syntax analysis;
the translation control unit, (a) if the information of the order to be translated is able to be delayed, delays outputting the translation result of the current units to be processed, (b) if the information of the order to be translated is not able to be delayed, adds the translation result of the current units to be processed to a non-output translation result of another unit to be processed to generate the text of the target language.

15. The product according to claim 14, wherein the dividing unit corrects the information of the order to be translated based on a difference between a time information according to a previously translated process and another time information according to a currently translated process.

16. The product according to claim 14, wherein the result of the syntax analysis represents whether the text of the source language divided by the divided position is a subordinate clause.

17. The apparatus according to claim 14 further comprising:
a correction unit that corrects a result of the speech recognition unit;
the translation control unit that adds, a translation result of the text of the source language corrected by the correction unit, to the current translation result, according to the information of order to be translated, to generate the text of the target language.
